(19) United States
(12) Patent Application Publication
(10) Pub. No.: US 2026/0131744 A1
(43) Pub. Date: May 14, 2026

(54) COHESIVE FRAMEWORK OF STANDARD COMPOSABLE VEHICLE SIGNALS FOR VEHICLE SYSTEM INTEGRATION

(71) Applicant: Google LLC, Mountain View, CA (US)

(72) Inventors: Eva S. Chen, Saratoga, CA (US); Julius D'Souza, San Francisco, CA (US); Edward Dcruz, Strongsville, OH (US)

(21) Appl. No.: 18/948,300

(22) Filed: Nov. 14, 2024

(51) Int. Cl. B60R 16/023; H04W 4/48

(52) U.S. Cl. CPC B60R 16/023; H04W 4/48

(57) ABSTRACT

A vehicle includes memory and processing circuitry, where the processing circuitry is configured to execute a vehicle hardware abstraction (VHAL) and a vehicle composite signal framework (VCSF). The VCSF manages component signals obtained from a plurality of vehicle services of the vehicle that include components of the vehicle and are representative of functions of the components. The VCSF obtains a component signal from a vehicle service of the plurality of vehicle services and processes the component signal into composite signal. The VCSF processes the component signal based on a mapping of the vehicle services to vehicle properties maintained by the VHAL layer. The VCSF provides the composite signal to an application executed by the processing circuitry.

### BACKGROUND

A modern automobile utilizes a variety of Electronic Control Units (ECUs) and Electronic Control Modules (ECMs) for the control of various electrical systems or subsystems within the vehicle. Typically, each ECU operates as a stand-alone embedded system within the electronic systems of the automobile responsible for controlling one or more of the subsystems of the vehicle. Some modern automobiles may have well over 150 distinct ECUs, drastically increasing the count of distinct ECU related components, the cost, and the complexity of the vehicle.

### SUMMARY

In general, this disclosure is directed to an improved communication framework for use in automobiles. More specifically, a vehicle composite signal framework is described which provides composite signal(s) to software applications, also referred to as “apps” and/or services, that are based on component signals generated by components of the vehicles, such as from Electronic Control Unit (ECU) type automobile subsystems and Software Defined Vehicle (SDV) type automobile subsystems.

A composite signal framework executing within an abstraction layer of the vehicle, for instance, within the infotainment system of the vehicle, processes component signals obtained from vehicle services of the vehicle into composite signals for consumption by applications. The composite signal framework may obtain component signals that vary in format from different vehicle services and components of the vehicle. For instance, the composite signal framework may process a component signal from an ambient light vehicle service into a composite signal based on a mapping between the service and a vehicle property to enable consumption via an application. The vehicle composite signal framework processes the component signals based on a mapping of vehicle services to vehicle properties and exposes an interface, such as an application programming interface (API), that facilitates the providing of the composite signals to the applications.

The vehicle hardware abstraction layer proxy provides the mapping between OEM installed automobile subsystems and properties of the vehicle, such as vehicle speed, vehicle thermostat settings, vehicle braking status, and so forth. Assuming sufficient permissions, the vehicle hardware abstraction layer proxy may communicate updated properties to the vehicle subsystems. For instance, if the vehicle temperature is increased at a user interface, the vehicle hardware abstraction layer proxy may communicate the increased temperate property to the appropriate vehicle subsystem based on the mapping. In a similar way, a software application executing at the infotainment system may retrieve updated temperature information from the vehicle hardware abstraction layer proxy via the API exposed by the vehicle signal composite framework.

In an example, a method includes executing, by processing circuitry of a vehicle, vehicle hardware abstraction layer and a vehicle composite signal framework, where the composite signal framework manages component signals obtained from a plurality of vehicle services of the vehicle; obtaining, by the processing circuitry, a component signal from a service of the plurality of vehicle services; processing, by the processing circuitry, the component signal into composite signal based on a mapping of the vehicle services to vehicle properties; and providing, by the processing circuitry, the composite signal to an application executed by the processing circuitry.

In another example, a vehicle computing system includes memory and processing circuitry in communication with the memory and configured to execute a vehicle hardware abstraction layer and a vehicle composite signal framework, where the composite signal framework manages component signals obtained from a plurality of vehicle services of the vehicle; obtain a component signal from a vehicle service of the plurality of vehicle services; process the component signal into composite signal based on a mapping of the vehicle services to vehicle properties; and provide the composite signal to an application executed by the processing circuitry.

In yet another example, non-transitory computer-readable storage media is encoded with instructions stored thereupon that, when executed, that, when executed, cause at least one processor of a vehicle computing system to execute a vehicle hardware abstraction layer and a vehicle composite signal framework, where the composite signal framework manages component signals obtained from a plurality of vehicle services of the vehicle; obtain a component signal from a vehicle service of the plurality of vehicle services; process the component signal into composite signal based on a mapping of the vehicle services to vehicle properties; and provide the composite signal to an application executed by the at least one processor.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 illustrates an example vehicle hardware abstraction layer that includes a vehicle composite signal framework, in accordance with one or more techniques of this disclosure.

FIG. 2 is a block diagram illustrating an example vehicle computing system that includes a vehicle composite signal framework, in accordance with techniques of this disclosure.

FIG. 3 is a block diagram illustrating an example architecture of a vehicle composite signal framework, in accordance with techniques of this disclosure.

FIG. 4 is a flow chart illustrating an example operation of a vehicle composite signal framework, in accordance with techniques of this disclosure.

Like reference characters denote like elements throughout the text and figures.

### DETAILED DESCRIPTION

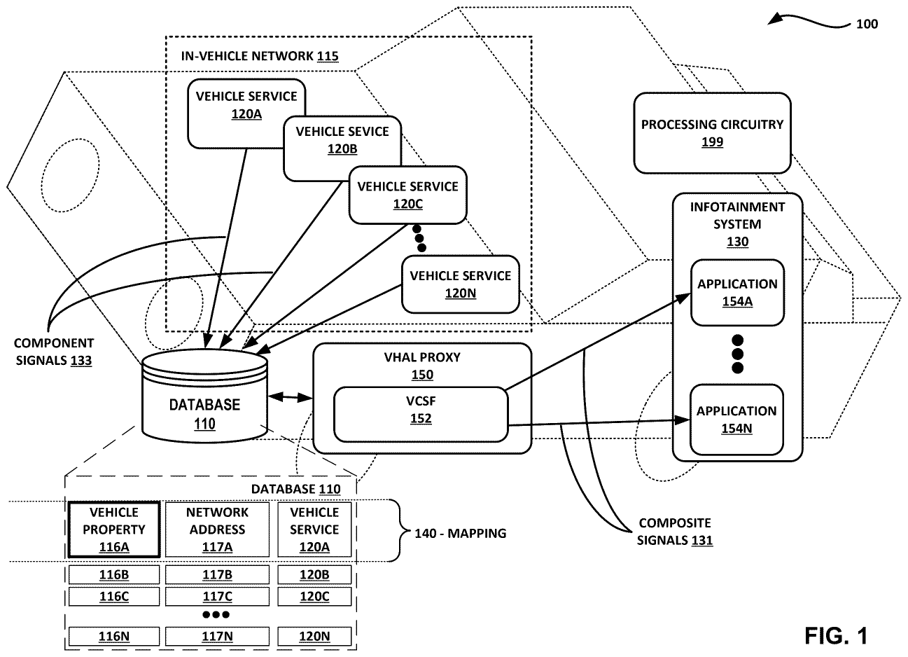

FIG. 1 illustrates an example vehicle hardware abstraction layer that includes a vehicle composite signal framework, in accordance with one or more techniques of this disclosure. In the example of FIG. 1, vehicle 100 includes vehicle hardware abstraction layer proxy 150 that (illustrated as “VHAL proxy 150” in FIG. 1 and referred to as such hereafter) manages vehicle properties 116A, 116B, 116C, 116N (collectively “vehicle properties 116”) and vehicle services 120A, 120B, 120C, 120N (collectively “vehicle services 120”) of vehicle 100 using database system 110 (illustrated as “DATABASE 110” in FIG. 1).

Vehicle 100 generally refers to automobiles such as cars, trucks, and vans, for the sake of simplicity and clarity within the description. However, techniques of this disclosure are not so limited. Rather, techniques described herein may be applied to a wide variety of vehicle 100 types, including motorcycles, recreational vehicles, farm vehicles and farm implements, aircraft, watercraft, and so forth. Vehicles 100 may include a plurality of components that provide various functionality.

Vehicle services 120 include services of vehicle 100 that are underpinned by one or more types of components, such as cameras, radar sensors, light detection and ranging (LIDAR) sensors, engine sensors, electronic control units (ECUs), radios, modems, microphones, rain sensors, light sensors, speed sensors, tire pressure monitor system (TPMS) sensors, rotational sensors, satellite navigation receivers (e.g., GPS, Galileo, GLONASS, etc.), display units (e.g., digital gauges, heads-up displays, etc.), and/or other types of components. Vehicle services 120 may communicate with each other and other components via in-vehicle network 115 and/or other communication networks. For example, a LIDAR sensor may communicate information regarding nearby obstacles to an ECU while vehicle 100 is being parked.

Various Software Defined Vehicle (SDV) modules may control vehicle services 120 such as radio and other multi-media operations, user configurable preferences such as interior LED colors and brightness, radar adaptive cruise control, and HVAC and/or climate control settings, such as interior cabin temperature, humidity, fresh-air intake, and so forth. A typical vehicle 100 may have dozens of different vehicle services, some of which may be ECU controlled whereas others are controllable using SDV modules. Some of vehicle services 120 may be user configurable and user selectable, such as audio volume, radio controls, climate temperature settings, whereas other vehicle services 120 may be wholly outside of the user controllable domain, such as engine air to fuel mixtures and engine ignition timing. Other settings, such as RPM limiter settings (also referred to as a “rev limiter”) may be vehicle dependent. For instance, an OEM manufacturer of an automobile may configure RPM shift thresholds for a family minivan that are both unviewable and unconfigurable for a vehicle operator. In other examples, the same OEM manufacturer of a different automobile, such as a high-performance exotic car, may provide a user interface to a vehicle operator via which the operator may not only view the RPM current state, but optionally re-configure the RPM shift thresholds within a pre-configured range established by the OEM manufacturer. Managing the increasing complexity and number of ECUs in a vehicle has become a key challenge for automobile manufacturers (also referred to as original equipment manufacturers or OEMs). Certain automobile manufacturers are beginning to transition away from the ECU model entirely in favor of adopting a Software Defined Vehicle (SDV) model for the various vehicle services 120. However, the transition is not immediate. Automobiles manufactured during this transition period will therefore operate ECU type vehicle subsystems concurrently alongside SDV type vehicle subsystems.

Vehicle Hardware Abstraction Layer (VHAL) proxy 150 may be an abstraction or application programming interface (API) layer described herein that may define various configurable vehicle properties which are implemented by the vehicle original equipment manufacturers. Each vehicle property may contain property metadata. For instance, such property metadata may define a variable type (e.g., such as INT, string, Boolean, etc.), access permissions, immutability and/or overwrite and update restrictions, as well as a uniquely addressable node and optionally a communication path via which the uniquely addressable node is reachable. For instance, in a vehicle network configuration with only a single in-vehicle network (IVN), a single uniquely addressable node address is sufficient. However, some vehicles may have multiple distinct in-vehicle networks, in which case, the property metadata may specify both a communication path (e.g., which in-vehicle network connects vehicle service 120 with VHAL proxy 150, as well as the address or uniquely addressable node address or location via which to communicate with vehicle service 120 using the specified communication path.

The metadata of vehicle properties 116 for each vehicle service 120 may additionally specify role-based access rights, such as which services are permitted to update a given vehicle property or may specify a required token or authentication parameter which may be provided with a request to update a given vehicle property. Generally, all vehicle properties may be read and/or viewed by other vehicle services, although this may optionally be restricted by specifying read access permissions using the metadata for one or more vehicle properties. Each vehicle service may implement separate access permissions which supersede any access permissions specified by VHAL proxy 150. For example, vehicle service 120 responsible for ABS braking may prohibit changes by other vehicle services not included on a whitelist, regardless of whether or not other vehicle services are permitted to update metadata for the ABS vehicle service proxy.

Vehicle services 120 may generate and provide component signals 133 as part of communication amongst themselves and with VHAL proxy 150. Component signals 133 may include one or types of signals or data transmissions according to various protocols, such as CAN bus, Time-Triggered Protocol (TTP), Local Interconnect Network (LIN), FlexRay, Media Oriented Systems Transport (MOST), Internet Protocol (IP), and/or other types of protocols. For example, vehicle service 120A may provide data in component signals 133 to infotainment system 130 via VHAL proxy 150.

In the example of FIG. 1, infotainment system 130 communicably interfaces with VHAL proxy 150. Processing circuitry, such as processing circuitry 199, may implement or execute VHAL proxy 150, including carrying out operations on behalf of VHAL proxy 150 to manage vehicle properties 116 and vehicle services 120 of vehicle 100 using database system 110. Database system 110 provides mapping 140 between vehicle properties 116 and vehicle services 120 which are reachable over in-vehicle network 115 using network address 117A, 117B, 117C, 117N (collectively 117). One network address 117 uniquely corresponds to each one of vehicle services 120. For instance, mapping 140 depicts vehicle service 120A is uniquely associated with network address 117A. Vehicle property 116A is also associated with vehicle service 120A. Updates to vehicle property 116A may be communicated to vehicle service 120A using network address 117A which may be determined using mapping 140. Similarly, a different mapping 140 is provided by database system 110 for vehicle service 120B which is reachable over in-vehicle network 115 via network address 117B. In the example of FIG. 1, vehicle service 120C is similarly reachable over in-vehicle network 115 via network address 117C and vehicle service 120N which is reachable over in-vehicle network 115 via network address 117N. In alternative examples, vehicle services 120A, 120B, 120C, 120N may be reachable over multiple different in-vehicle networks 115 using corresponding network addresses 117A, 117B, 117C, 117N recorded in database system 110 using one or more mappings 140.

Database system 110 may provide an organized collection of structured information, or data, stored electronically within memory and/or persisted within a datastore. Database system 110 may implement a database management system (DBMS) which manages stored data, relationships, database queries, updates, conflicts, and so forth. Collectively, the data stored within a database system, the DBMS, along with associated applications may be referred to as a “database system,” which is often shortened to simply a “database.” Many structured query language (SQL) type database system 110 implementations arrange data modeled using rows and columns in a series of tables having defined relationships between them to make data storage, data processing, and data querying more efficient. Data may be accessed, managed, modified, updated, controlled, and organized using a structured query language (SQL) for writing and querying data.

Network addresses 117A, 117B, 117C, and 117N (collectively 117) refer to one or more addresses on in-vehicle network 115 and/or one or more network addressable nodes on in-vehicle network 115 reachable using one of network addresses 117. Also referred to as vehicular communication systems, each in-vehicle network 115 provides a communication path to at least one vehicle service 120 node or an endpoint of in-vehicle network 115 capable of interacting with VHAL proxy 150 and/or other in-vehicle nodes, units, and modules providing one or more vehicle services.

Mapping 140 establishes an association between the mapped elements as managed by database system 110. In the example of FIG. 1, vehicle mapping 140 expressly links network address 117A with property 116A and vehicle service 120A. Therefore, VHAL proxy 150 may read, alter, update, subscribe, or broadcast data in association with vehicle service 120 utilizing network address 117A specified by mapping 140.

For instance, consider an example where vehicle service 120A is a vehicle speedometer. In such an example, VHAL proxy 150 may read the current speed property 116A from vehicle service 120A utilizing network address 117A. VHAL proxy 150 may store that information or relay the “current speed” vehicle property 116A to another vehicle service 120 or to an OEM provided or third-party provided software application. For example, VHAL proxy 150 may be configured to iteratively report current vehicle speed to an auxiliary speedometer readout provided to a navigational application executing via infotainment system 130.

In a similar manner, VHAL proxy 150 may receive component signal 133 that includes a new value for a given vehicle property 116 and store the new value in association with vehicle property 116 within database system 110. Consider for instance, the example from above with the navigational software application executing on infotainment system 130. The navigational software application may provide a user input interface via which to set a “ride comfort” preset, wholly separate from an OEM provided “ride comfort” input (e.g., a button or switch typically on a center console for setting ride comfort damping presets to soften or stiffen front and/or rear springs or change responsiveness of the springs to alter comfort settings based on road and driving conditions, sometimes labeled as “sport,” “cruise,” “comfort,” “off-road,” “snow,” and so forth). In such an example, assuming sufficient access permissions, the navigational software application may accept composite signals 131 with a new value for vehicle property 116 associated with “ride comfort” settings. The navigational software application may then communicate the setting to VHAL proxy 150 which writes the updated value into database system 110. For instance, VHAL proxy 150 may write the new value to vehicle property 116A (now ride comfort in this example rather than current speed). Depending on the configuration of the corresponding vehicle service 120A specified via mapping 140, VHAL proxy 150 may push the new value written into vehicle property 116A to vehicle service 120A using network address 117A according to mapping 140 or VHAL proxy 150 may simply permit vehicle service 120A to read the new value written into vehicle property 116A for vehicle service 120A using network address 117A. Other communication methods include vehicle service 120A subscribing to changes reflected by property 116A or VHAL proxy 150 broadcasting the new value using network address 117A.

Regardless of the specific communication mechanism, through the use of VHAL proxy 150, each of OEM provided software applications, OEM provided user controls (e.g., switches, buttons, etc.) and third-party provided software applications executing at infotainment system 130 or indirectly interfaced with infotainment system 130 may read data from, and optionally update with new values to, variously provided vehicle services 120 of vehicle 100 through VHAL proxy 150.

In the example of FIG. 1, vehicle hardware abstraction layer proxy (VHAL proxy) 150 may be configured as a collection of executable instructions stored within memory or other persistent storage, that, when executed, defines various vehicle properties 116 OEMs may implement for a specific automobile. VHAL proxy 150 may further define metadata for each vehicle property 116, for example, whether a given vehicle property 116 is an int, string, floating point variable, Boolean, or an enumerated set, as well as permissions specifying whether or not any change modes are allowed for each vehicle property 116. VHAL proxy 150 may further define access permissions (e.g., access parameters) specifying operations for each vehicle property 116 such as read, write, update, subscribe, etc.

Processing circuitry 199 may include the logic circuitry that responds to and processes the basic instructions that, when executed, cause a computing system to perform operations. Processing circuitry 199 may include a centralized computing system module such as a System On a Chip or “SOC” type processing circuitry type device or a collection of interconnected components, such as a central processing unit (CPU) for executing operations and computer instructions, memory for storing computer instructions, Input/Output (I/O) components, communication busses, signal processing components, and so forth.

Processing circuitry 199 of vehicle 100 executes infotainment system 130, including executing an operating system for infotainment system 130 capable of executing OEM provided and third-party (e.g., non-OEM) provided software applications. Infotainment system 130 may be a software component of vehicle 100 that provides information and entertainment to a user of vehicle 100. For example, infotainment system 130 may provide information regarding the status of vehicle 100 (e.g., tire pressure, fuel level, etc.) as well as other functions (e.g., radio, music streaming, navigation, games, etc.) that is obtained from vehicle services 120. For instance, a vehicle owner, vehicle occupant, and/or vehicle passenger may download an “app” from an “app store” (e.g., a cloud connected marketplace for software applications) and install the app at infotainment system 130. In some examples, an original equipment manufacturer may pre-install an OEM provided software application at infotainment system 130. In other examples, the original equipment manufacturer provided software application may be downloaded and installed to infotainment system 130 while being operated by a vehicle owner or operator. For instance, the original equipment manufacturer may push a new software application or an update to an existing software application to infotainment system 130 via an “over-the-air-update” also referred to as an OTA update. Such updates may provision new firmware for ECUs and ECMs of the vehicle or new software parameters for SDV modules of the vehicle. In other examples, infotainment system 130 executes a software application configured as a vehicle widget, such as a small user interface which is frequently utilized by a vehicle occupant (e.g., an infotainment software application for changing the radio station or altering the climate controls). In some examples, infotainment system 130 may execute a customer installed software application which is not provided by the original equipment manufacturer of vehicle 100. In some examples, infotainment system 130 may execute a communications bridge application for communicating between infotainment system 130 of vehicle 100 and a mobile device communicably interfaced with vehicle 100. Stated differently, processing circuitry 199 of infotainment system 130 may communicate with various types of software applications from various points of origin, including non-OEM software developed by third-party software developers and software downloaded by a user from a marketplace for software applications. In a similar manner, infotainment system 130 may receive input, data, commands, and user interactions from a variety of software types. For instance, in some examples, processing circuitry 199 receives input from an original equipment manufacturer installed software application. Infotainment system 130 may receive input, data, commands, and user interactions from a software application executing at infotainment system 130 having a user interface configured as a vehicle widget. Infotainment system 130 may receive input, data, commands, and user interactions from a customer installed software application. Infotainment system 130 may receive input, data, commands, and user interactions from a mobile device communicably interfaced with vehicle 100 through a communications bridge application.

Infotainment system 130 may provide an execution environment for applications 154A-154N (collectively “applications 154”), which may include a variety of first-party and third-party applications (e.g., games, navigation, social media, music streaming, etc.). Applications 154 may use data obtained from vehicle services 120 as part of providing functionality to a user of vehicle 100. For example, application 154A may use information obtained from an ambient light sensor of vehicle services 120 to determine whether to generate a user interface in a “light” mode or a “dark” mode. Applications 154 may obtain the data from vehicle services via VHAL proxy 150.

Developers of application 154 may find it challenging to develop applications 154 as capable of interfacing with multiple types of vehicles from different manufacturers due to differences in design and configuration between manufacturers and vehicle models. For example, a first manufacturer may configure light sensors in their vehicles to provide data in a first format while a second manufacturer configures their light sensors to use an entirely different format. Further, manufacturers may change the design and configuration of in-vehicle networks, such as in-vehicle network 115, and vehicle services 120 even between model years. Developers may need to configure applications 154 to account for differences between vehicles in a costly and time-consuming process. Due to this cost and complexity, some developers may refrain from adding functionality to applications 154 due to the prohibitive costs and complexities of ensuring capability with different vehicles.

In accordance with the disclosed techniques, vehicle composite signal framework 152 (illustrated as “VCSF 152” in FIG. 1 and referred to as such hereafter) processes data obtained via VHAL proxy into composite signals 131 for consumption by applications 154 and/or services of vehicle 100. VCSF 152 may be a software component of VHAL proxy 150 that includes sub-components that process component signals 133 from vehicle services 120. For example, VCSF 152 may include a sub-component that processes signals from a camera and ambient light of vehicle services 120 into an aggregated composite signal.

While illustrated as included within VHAL proxy 150, VCSF 152 may execute in an abstraction layer above or below VHAL proxy 150. For instance, VCSF 152 may execute within the abstraction layer of VHAL proxy 150 or as a surface built on VHAL proxy 150 as a comparatively higher level of abstraction. In such a case, VCSF 152 may provide one or more standardized interfaces that surface signals that are processed through VHAL proxy 150 or other such abstraction layer.

VCSF 152 determines a declarative mapping of component signals 133 received by VHAL proxy 150 to vehicle properties 116 based on mapping 140. VCSF 152 may compare the source of a component signal of component signals 133 (e.g., which vehicle service generated the component signal) and determine a mapping of the signal to a vehicle property based on the mapping 140. In an example, VCSF 152 receives a signal from vehicle service 120A. VCSF 152 determines that the signal should be mapped to property 116A based on mapping 140. VCSF 152 may map all of component signals 133 or only a portion of component signals 133 based on mapping 140.

VCSF 152 processes component signals 133 into composite signal 131 for consumption by applications 154. VSCF 152 may process component signals 133 that include data in non-standardized formats (e.g., manufacturer-and/or model-specific formats of data) into a standardized format of composite signals 131. For example, VCSF 152 may receive component signals 133 from vehicle services 120A, 120B that are in a non-standardized format. VCSF 152 processes component signals 133 into a standardized format of composite signals 131. VCSF 152 may process component signals 133 into one or more standardized formats specified by mapping 140. For example, VCSF may process camera signals received from a camera service into a first format based on mapping 140 and temperature signals received from a temperature sensor into a second format based on mapping 140.

VCSF 152 may provide composite signal 131 to application 154 in response to a request from one or more of applications 154. VCSF 152 may expose an application programming interface (API) to enable applications 154 to query VCSF 152 and obtain composite signal 131 for consumption. VCSF 152 may expose an API that enables applications 154 to obtain specific types of composite signal 131 (e.g., hard braking events, ambient light status, interior/exterior temperature, etc.). In an example, VCSF 152 exposes an API that enables application 154A to query for data regarding ambient light that is a composite of signals received from a light sensor and a camera of vehicle 100.

Applications 154 may utilize composite signals 131 to provide a variety of functionality for vehicle 100 that includes entertainment and vehicle control. For example, application 154A may use information included in composite signals 131 to determine a status of a climate control system of vehicle 100 and issue commands to change climate settings based on the current status of the climate control system. Applications 154 may issue commands to vehicle services 120 via VHAL proxy 150.

The techniques described in this disclosure may provide one or more practical advantages. For example, the processing of component signals into composite signals based on a mapping of vehicle services to properties may obviate the need for application developers to develop applications that are capable of ingesting data in non-standard formats and thereby reduce the costs and complexity associated with application development. In another example, VCSF 152 may enable applications 154 to obtain data from a range of vehicle components and services via a single API as opposed to needing to query individual services for data.

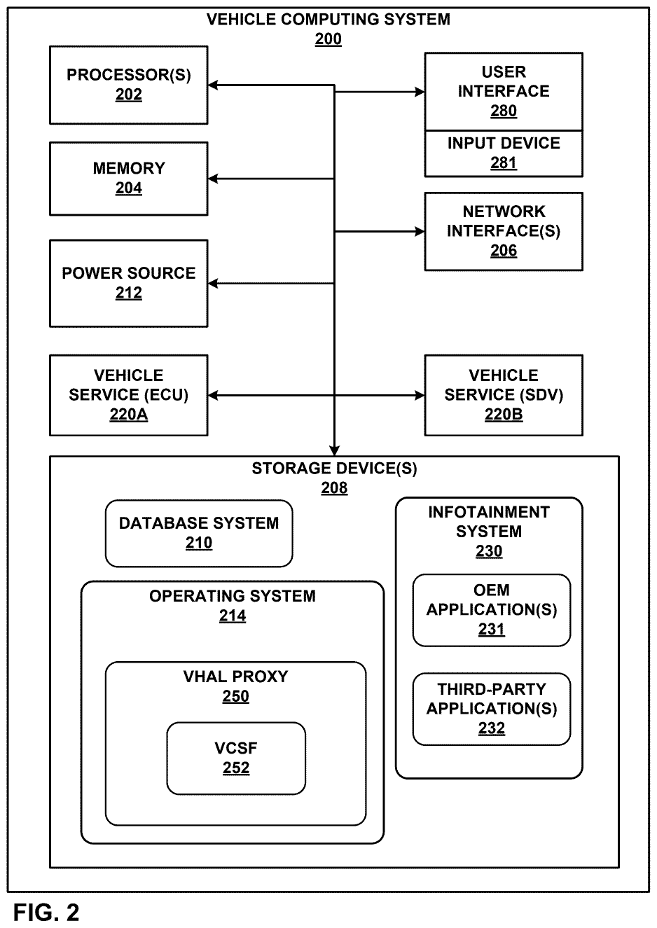

FIG. 2 is a block diagram illustrating an example vehicle computing system that includes a vehicle composite signal framework, in accordance with techniques of this disclosure. Vehicle computing system 200 may be included in a vehicle, such as vehicle 100 as illustrated in FIG. 1, and enable various functions of vehicle 100.

Vehicle computing system 200 includes one or more of processors 202. Processors 202 may include processing circuitry, multi-core processors, single-core processors, embedded processors, virtualized computing environments, chiplets, digital signal processors (DSPs), general purpose microprocessors, application specific integrated circuits (ASICs), field programmable logic arrays (FPGAs), or other equivalent integrated or discrete logic circuitry. Processors 202 may implement functionality and/or process instructions for execution within vehicle computing system 200. For example, one or more processors 202 may be capable of processing instructions stored in memory 204.

Vehicle computing system 200 includes memory 204, which may be one or more types of memory. Memory 204 may include volatile memory, such as random access memory (RAM), dynamic random access memory (DRAM), and/or other types of volatile memory. Memory 204 may include types of memory specific to vehicle applications (e.g., memory hardened to function in environments with substantial temperature variations and/or electromagnetic interference). In some examples, memory 204 may include non-volatile memory.

Vehicle computing system 200 includes one or more of network interfaces 206. Vehicle computing system 200 may use network interface 206 to communicate with external devices via one or more networks, such as one or more wired or wireless networks as well as services of vehicle 100 via an in-vehicle network (e.g., in-vehicle network 115 as illustrated in FIG. 1). Network interface 206 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 5G, 5G, LTE, and WI-FI® radios in mobile vehicle computing devices as well as USB. In some examples, vehicle computing system 200 may use network interfaces 206 to wirelessly communicate with an external device such as a server, mobile phone, or other networked vehicle computing device. For instance, an in-vehicle WI-FI type network interface may be utilized to communicate with a nearby smartphone or tablet. A satellite receiver of an in-vehicle network, such as one of network interfaces 206, may receive a satellite-based radio broadcast (e.g., satellite-based audio content broadcasts) and a cellular type in-vehicle network interface may be utilized to communicate with cloud-based services via the public Internet.

Vehicle computing system 200 includes user interface 280. User interface 280 may include one or more input devices 281, such as a touch-sensitive display utilized to provide display output by infotainment system 230. Input device 281, in some examples, may be configured to receive input from a user through tactile, electromagnetic, audio, and/or video feedback. Examples of input device 281 may include a touch-sensitive display, mouse, keyboard, voice responsive system, video camera, microphone or any other type of device for detecting gestures by a user. In some examples, a touch-sensitive display may include a presence-sensitive screen.

User interface 280 may also include one or more output devices. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a view monitor, a liquid crystal display (LCD), or any other type of device that can generate intelligible output to a user. Some output devices within a vehicle may produce analog output or digital to analog output, or digitized output that mimics an analog output display, such as a speedometer indicator that sweeps across a dial rather than displaying a numeric value as digital output. Other examples include a fuel gauge and/or a temperature gauge which may output display information in an analog format regardless of originating from an analog or digitized source.

Vehicle computing system 200 includes power source 212, which may be rechargeable and provide power to vehicle computing system 200. Power source 212, in some examples, may include a battery made from lead-acid, nickel-cadmium, lithium-ion, or other suitable material. Vehicle computing system 200 may be powered by a battery of an internal combustion engine (ICE) vehicle, by a battery of a hybrid vehicle, and/or from a battery of an all-electric vehicle.

Vehicle computing system 200 includes vehicle service 220A (shown as an ECU-type and vehicle service 220B (shown as an SDV-type). While illustrated as two services, vehicle computing system 200 may include a plurality of vehicle services, such as vehicle services 120 as illustrated in FIG. 1, that are ECU-type and/or SDV-type services. In an example, vehicle service 220 is an ECU-type service and reports a current speed of vehicle 100 while vehicle service 220B is an SDV-type service and reports hard-braking events detected by vehicle 100.

Vehicle computing system 200 includes one or more of storage devices 208, which may include one or more types of computer-readable storage media. One or more storage devices 208 may store larger amounts of information than memory 204 and provide long-term storage of information. In some examples, one or more storage devices 208 may include non-volatile storage elements. Examples of such non-volatile storage elements may include magnetic hard disks, optical discs, Flash memories, NVME drives, and/or other forms of electrically programmable memories (EPROM) or electrically erasable and programmable (EEPROM) memories. Storage devices 208 may store instructions of one or more software components of vehicle computing system 200 for execution by processors 202.

Storage devices 208 include operating system 214 (hereinafter “OS 214”). OS 214 may be an operating system, such as an embedded operating system, automotive operating system, or other type of operating system and provide an execution environment for one or more software components of vehicle computing system 200. For example, OS 214 may provide an execution environment for database system 210.

Storage devices 208 include database system 210, which may be similar to database system 110 as illustrated in FIG. 1. Database system 210 may be a system provided by vehicle computing system 200 that manages and maintains a collection of structured information regarding vehicle services 220 and mappings of vehicle services 220 to network addresses and vehicle properties. In an example, vehicle computing system 200 updates database system 210 to include an entry of vehicle service 220A mapped to a speedometer vehicle service.

Operating system 214 includes VHAL proxy 250, which may be similar to VHAL proxy 150 as illustrated in FIG. 1. For example, VHAL proxy 250 may be a software component that provides an abstraction layer between hardware components of vehicle computing system 200 and a software layer of vehicle computing system 200. VHAL proxy 250 may define various configurable vehicle properties and maintain property metadata that includes variable types, access permissions, immutability, read/write restrictions, and/or other information. VHAL proxy may include one or more software components.

VHAL proxy 250 includes vehicle component software framework 252 (illustrated as “VCSF 252” in FIG. 2, referred to as such hereafter). VCSF 252 may provide a framework for processing component signals received from vehicle services 220 into composite signals for consumption by applications. In an example, VCSF 252 processes a component signal received from vehicle service 220A into a composite signal based on a mapping between vehicle services and vehicle properties maintained by database system 210. VCSF 252 provides the composite signal to infotainment system 230 via an API. In some examples, VCSF 252 is agnostic of vehicle manufacturer and provides the composite signal as adhering to a standardized format.

Storage devices 208 include infotainment system 230, which may be a software component of vehicle computing system 200 that provides information and entertainment functionality. Infotainment system 230 may be integrated into vehicle computing system 200 and associated with one or more user interface components, such as input device 281. For example, infotainment system 230 may enable a user of vehicle computing system 200 to interact with applications via input device 281. Infotainment system 230 may generate user interface 280 and cause one or more user interface devices to output user interface 280 for display.

Infotainment system 230 includes one or more of OEM applications 231, which may be applications provided by a manufacturer of vehicle computing system 200. OEM applications 231 may include applications that provide functionality directly or traditionally associated with the operation of the vehicle of vehicle computing system 200 (e.g., climate control, safety features, start-stop, performance modes, locks, adaptive cruise control, radio, self-driving features, etc.) as well as other functions. For example, an application of OEM applications 231 may manage fast-charging of a battery of the vehicle of vehicle computing system 200.

Infotainment system 230 includes one or more of third-party applications 232, which may be applications other than those associated with a manufacturer of the vehicle of vehicle computing system 200. Third-party applications 232 may include applications that are preloaded on storage devices 208 as well as applications that are obtained from another source, such as an application store. Third-party applications 232 may include applications that provide various functionality, such as navigation, vehicle usage tracking (e.g., insurance, parental controls, etc.), games, music streaming, video streaming, and/or other functionality.

OEM applications 231 and/or third-party applications 232 may obtain information regarding vehicle services 220 from VCSF 252 as part of providing functionality to a user of vehicle computing system 200. In an example, a navigation application of third-party applications 232 obtains information regarding whether it is dark outside the vehicle by way of a current status of a vehicle service associated with ambient light levels via VCSF 252. Based on the current status being indicative of it being dark outside the vehicle, the navigation application generates a user interface in a dark mode.

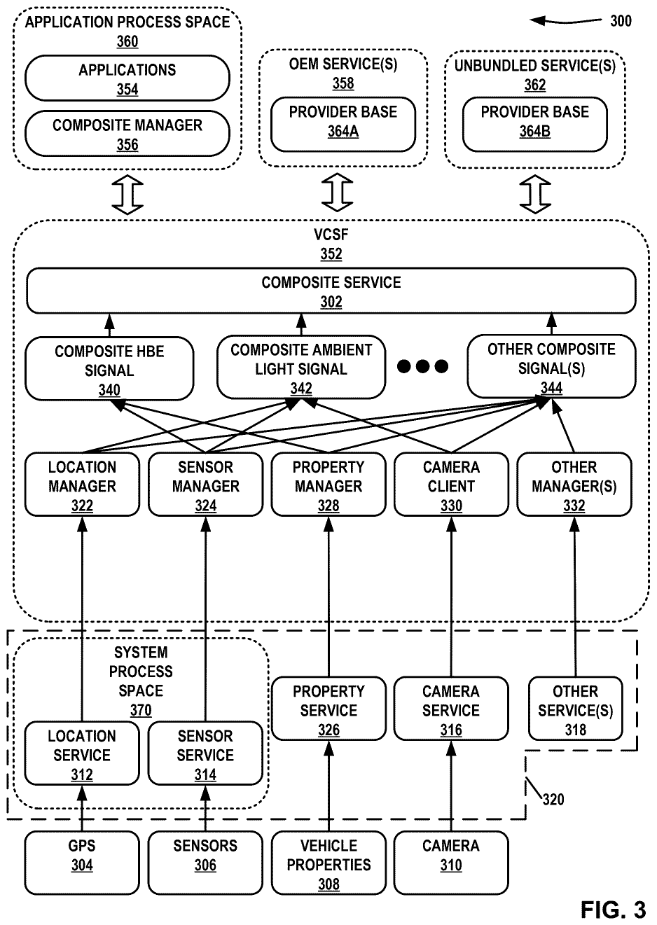

FIG. 3 is a block diagram illustrating an example architecture 300 of a vehicle composite signal framework 352, in accordance with techniques of this disclosure. Vehicle composite signal framework 352 (illustrated as “VCSF 352” in FIG. 3 and referred to as such hereafter) may be similar to VCSF 152 as illustrated in FIG. 1. For example, VCSF 352 may provide a communications framework within an abstraction layer (e.g., VHAL proxy 150 as illustrated in FIG. 1) for a vehicle that includes one or more vehicle services (e.g., vehicle services 120 of vehicle 100 as illustrated in FIG. 1).

Architecture 300 includes components of vehicle 100, such as GPS 304, sensors 306, and camera 310 that generate data for one or more of vehicle services 320. GPS 304 may include one or more components that provide satellite location and navigation service (e.g., GPS, Galileo, GLONASS, etc.). Sensors 306 may include a variety of vehicle sensors, such as parking sensors, light sensors, LIDAR sensors, speed sensors, tire pressure sensors, etc. Camera 310 may include one or more cameras, such as visual light cameras, infrared cameras, etc. The components of vehicle 100 may generate data organized into vehicle services 320.

Architecture 300 includes vehicle properties 308, which may be properties of the vehicle assigned by a manufacturer of vehicle 100 and/or a developer of VHAL proxy 150. Vehicle properties 308 may include properties similar to those of properties 116 as illustrated in FIG. 1. For example, vehicle properties 308 may include metadata regarding one or more configurable vehicle parameters.

Architecture 300 includes vehicle services 320 which may be similar to vehicle services 120 as illustrated in FIG. 1 and provide various functionalities of vehicle 100. Vehicle services 320 include services of vehicle 100 that are underpinned by one or more components, such as GPS 304 and camera 310. A computing system of vehicle 100 may aggregate data from one or more components into vehicle services 320.

Vehicle services 320 include property service 326, camera service 316, and one or more of other services 318. Property service 326 may be a software component of architecture 300 that aggregates and processes vehicle properties 308 into properties of vehicle 100. For example, property service 326 may process vehicle properties 308 and provide a service to facilitate consumption of vehicle properties by property manager 328. Camera service 316 may be a software component of architecture 300 that processes data generated by camera 310 into a component signal that includes the data from camera 310. Other services 318 may include one or more other services of vehicle 100 and may generate component signals based on data received from the other components of vehicle 100.

Vehicle services 320 include services within system process space 370, which may be a software component of architecture 300. In some examples, system process space 370 may be incorporated into an operating system of vehicle 100. System process space 370 may provide an execution environment for one or more of vehicle services 120. In the example of FIG. 3, system process space 370 provides an execution environment for location service 312 and sensor service 314. Location service 312 may be a vehicle service of vehicle services 320 that processes data from GPS 304 and other satellite location services into a component signal. Sensor service 314 may be a vehicle service of vehicle services 320 that processes data from sensors 306 into a component signal.

VCSF 352 may obtain component signals from vehicle services 320 and process the component signals using one or more software components. VCSF 352 may obtain the signal directly from vehicle services 320 and/or from the VHAL proxy. For example, VCSF 352 may process component signals obtained by VHAL proxy 150 from vehicle services 320 into composite signals using one or more managers that include location manager 322, sensors manager 324, property manager 328, camera client 330, and other managers 332.

In some examples, the processing circuitry executing VCSF 352 may obtain component signals that are preprocessed by one or more components of vehicle 100. The one or more components of vehicle 100 may preprocess the component signals into one or more formats and/or to modify the component signal. For example, another component of vehicle 100 may process signals from camera 310 into component signals before the processing circuitry obtains the component signal for use by VCSF 352.

VCSF 352 may use a mapping provided by property manager 328 to organize component signals received by VCSF 352 into composite signals. Property manager 328 may be a software component of VCSF 352 that manages vehicle properties 308 obtained by property service 326 and determines mappings of vehicle services 320 to vehicle properties 308. For example, property manager 328 may determine a mapping between composite signals received by sensor manager 324 and camera client 330 to composite ambient light signal 342. VCSF 352 may cause or otherwise configure the one or more managers to process component signals into composite signals based on the mapping.

VCSF 352 includes location manager 322, sensor manager 324, property manager 328, camera client 330, and one or more other managers 332, which may software components of VCSF 352 that process and organize component signals for incorporation into composite signals based on the mapping by property manager 328. Location manager 322 may process component signals from location service 312 that are related to satellite location data into one or more composite signals. Sensor manager 324 may process component signals from sensors service 314 that are generated by sensor service 314 based on data from sensors 306. Camera client 330 may process component signals from camera service 316 into one or more composite signals, such as composite ambient light signal 342, based on a composite signal from camera service 316. One or more of other managers 332 may process composite signals from corresponding services of other services 318 into one or more composite signals.

The managers of VCSF 352 (e.g., location manager 322, sensor manager 324, property manager 328, camera client 330, and one or more other managers 332) may associate the component signals with one or more vehicle properties to generate a declarative mapping of the component signals to the composite signals. The managers may use a mapping of vehicle services 320 to vehicle properties to generate a declarative mapping. The declarative mapping may include a standardized mapping of the component signals to vehicle properties. In an example, camera client 330 receives a component signal from camera service 316. Camera client 330 determines that the component signal should be associated with composite ambient light signal 342 and other composite signals 344 based on the declarative mapping between the component signal and vehicle properties associated with composite ambient light signal 342 and other composite signals 344.

VCSF 352 may process the component signals received from vehicle services 320 to conform the component signals to a standard associated with the mapping to vehicle properties 308. Property manager 328 may maintain the declarative mapping as including one or more standards to which the composite signals must adhere to. For example, property manager 328 may maintain the declarative mapping as including standards for data formats and other requirements. VCSF 352 may use the standards to enable VCSF 352 to operate as agnostic of vehicle manufacturer. The use of standards associated with the mapping may ensure that VCSF 352 provides standardized composite signals regardless of any manufacturer-specific format of the composite signals received from vehicle services 320. In some examples, VCSF 352 may enable a manufacturer of vehicle 100 and/or developer of VCSF 352 to define implementations of the composite signals. In addition, VCSF 352 may process only a portion of composite signals using declarative mapping (e.g., not all composite signals may require such a mapping).

In some examples, VCSF 352 may process composite signals that are pre-processed by one or more components. VCSF 352 may process composite signals that are pre-processed by the one or more components to include information other than raw data from one or more vehicle components. In an example, a manufacturer configures camera 310 to provide an indication of a forward collision alert rather than provide the data generated by camera 310 and thereby expose an image recognition algorithm used by the manufacturer to identify potential forward collisions. Camera client 330 processes a composite signal that includes the indication obtained from camera service 316 into one or more composite signals.

In some examples, VCSF 352 may process events published by one or more additional services, such as one or more of OEM services 358 and/or unbundled services 362 via provider base 364A and 364B, respectively (hereinafter “provider bases 364”). OEM services 358 may include one or more services provided by a manufacturer of vehicle 100 that generate and publish events to VCSF 352. In addition, unbundled services 362 may include one or more additional services provided by a third-party that generate and publish events to VCSF 352. OEM services 358 and unbundled services 362 may publish event events via provider bases 364, where provider bases 364 are software components of architecture 300 that include one or more APIs. In an example, a service of OEM services 358 generates a hard-braking event. The service publishes the event via provider base 364A for inclusion in the composite signals of composite service 302.

VCSF 352 may process component signals into composite signals that include composite HBE signal 340, composite ambient light signal 342, and one or more of other composite signals 344. Composite HBE signals 340 may be a composite signal indicative of the detection of hard braking events, composite ambient light signal 342 may be a composite signal indicative of ambient light levels of an environment of vehicle 100, and other composite signals 344 may include one or more composite signals indicative of other states and/or events related to vehicle 100, such as collision detection, weather conditions (e.g., fog, snow, heavy rain), road characteristics (e.g., gravel vs. paved, road smoothness, etc.), tire pressure (e.g., indication of root cause of tire pressure, such as altitude, temperature, flat tire, erroneous sensors), vehicle occupancy, self-driving features, and/or other states and events.

VCSF 352 may combine one or more component signals into single composite signals based on the mapping provided by property manager 328. For example, VCSF 352 may process component signals from location service 312, sensor service 314, and camera service 316 into composite ambient light signal 342 as the component signals may all be relevant to a composite signal indicative of ambient light levels (i.e., composite ambient light signal 342).

VCSF 352 may use composite service 302 to manage the composite signals and provide the composite signals to one or more recipients. Composite service 302 may be a software component of VCSF 352 that aggregates and manages the composite signal to provide a single source of the composite signals for consumption by the one or more recipients. In addition, composite service 302 may track registered and/or available providers of composite signals as well as a mapping of interfaces to supported types of composite signals. For example, composite service 302 may configure and expose an interface for one or more recipients to obtain and consume composite HBE signal 340. Composite service 302 may provide the composite signals to one or more of applications 354 in response to a query from applications 354.

Architecture 300 includes application process space 360, which may be an execution environment for one or more of applications 354. Application process space 360 may provide the execution environment within an infotainment system, such as infotainment system 130 as illustrated in FIG. 3. For example, application process space 360 may facilitate the execution of applications 354 by infotainment system 130. Applications 354 may include one or more applications executing within application process space 360 and may be similar to applications 154 as illustrated in FIG. 1. For example, applications 354 may include a dashcam application, a tire pressure alert application that provides proactive tire pressure alerts, a dashcam application, a smart/artificial intelligence-enabled assistant, and/or other application. In addition, applications 354 may obtain composite signals from VCSF 352 via composite manager 356.

Application process space 360 includes composite manager 356, which may be a software component that facilitates access for applications 354 to the interfaces exposed by composite service 302. Composite manager 356 may maintain definitions, such as enum definitions, for supported types of composite signals and APIs that facilitate access to the composite signals for applications 354. Composite manager 356 may obtain one or more composite signals from composite service 302 via the APIs based on requests from applications 354. In an example, a navigation application of applications 354 requests composite ambient light signal 342. Composite manager 356 uses an API to obtain composite ambient light signal 342 via an interface exposed by composite service 302 and provides composite ambient light signal 342 to the navigation application. In another example, a dashcam application of application 354 requests composite HBE signal 340 and a video composite signal of other composite signals 344 to record video from vehicle 100 during hard-braking events. Composite manager 356 may include one or more standardized APIs that facilitate obtaining the composite signals and that may reduce complexities associated with permissions regarding the composite signals.

In some examples, infotainment system 130 may use composite signals for one or more purposes. For example, infotainment system 130 may use composite signals from composite services 302 to determine whether to place infotainment system 130 into a passenger mode.

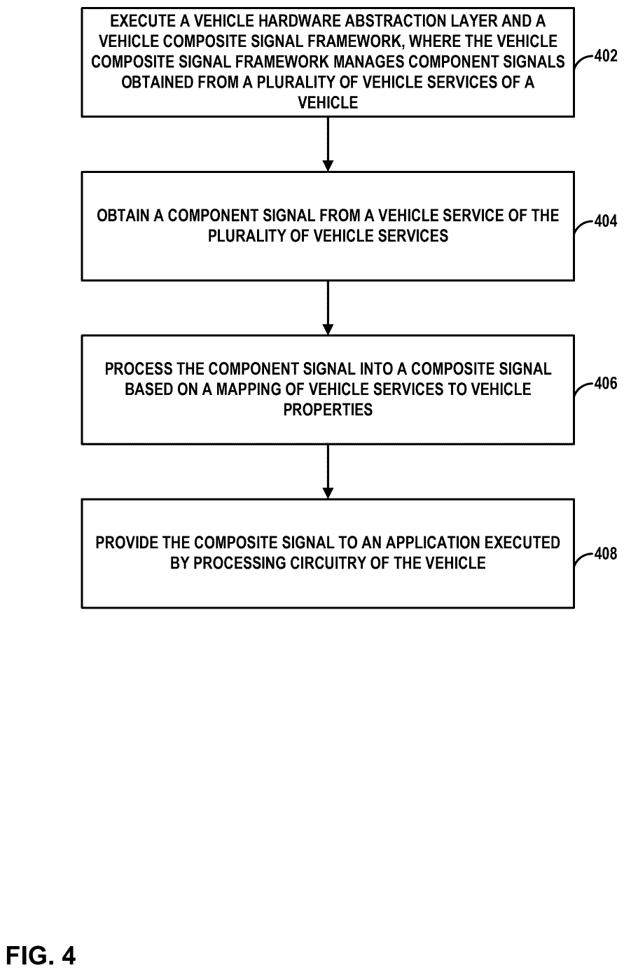

FIG. 4 is a flow chart illustrating an example operation of a vehicle composite signal framework, in accordance with techniques of this disclosure. For the purposes of clarity, FIG. 4 is described in the context of FIG. 1.

Processing circuitry, such as processing circuitry 199, executes a vehicle hardware abstraction layer, such as VHAL proxy 150, and a vehicle composite signal framework, such as VCSF 152, where VCSF 152 manages component signals obtained from a plurality of vehicle services of a vehicle, such as component signals 133 from vehicle service 120 of vehicle 100 (402). Processing circuitry 199 may execute VHAL proxy 150 and VCSF 152 as part of an operating system of vehicle 100. In some examples, processing circuitry 199 may execute VCSF 152 as included in VHAL proxy 150 or in an abstraction layer logically above the abstraction layer of VHAL proxy 150.

VCSF 152 obtains a component signal of component signals 133 from a vehicle service of vehicle services 120 (404). VCSF 152 may obtain composite signals 133 that are generated by vehicle services 120 and based on data generated by physical and/or software components of vehicle 100. VCSF 152 may obtain component signals that are pre-processed by a component of vehicle 100 prior to being obtained by processing circuitry 199. In some examples, VCSF 152 may obtain component signals 133 that include events published by OEM and/or unbundled services.

VCSF 152 processes the component signal into a composite signal, such as a composite signal of composite signal 131, based on a mapping of vehicle services 120 to vehicle properties, such as mapping 140 of vehicle properties 116 to vehicle services 120 (406). VCSF 152 may aggregate multiple of component signals 133 into a single composite signal. For example, VCSF 152 may aggregate a component signal from a camera service and a component signal from a light sensor service into an ambient light composite signal. VCSF 152 may further process component signals 133 to adhere to standardized formats associated with vehicle properties 116. For example, VCSF 152 may process component signals 133 from a camera service to conform the component signals to a standardized format.

VCSF 152 provides composite signals 131 to an application executed by processing circuitry 199 of vehicle 100, such as an application of applications 154 (408). VCSF 152 may expose one or more interfaces and/or include one or more APIs that enable applications 154 to obtain composite signals 131. In some examples, VCSF 152 may provide composite signals 133 in response to a request from applications 154.

Applications 354 may use the composite signals from VCSF 352 to provide functionality for a user of vehicle 100. Applications 354 may provide functionality that includes route planning, event-based triggering of a dashcam, drive scoring for insurance, driver assistance during a safety incident, insurance claims and accident verification, optimizing route safety based on weather conditions, displaying real-time dynamic updates of weather conditions, optimization of route planning based on road quality, recommending action items based on root causes of tire pressure warnings, re-routing navigation based on tire pressure warnings, high occupancy lane routing based on passenger count and seat position, logging out and/or privacy filtering based on passenger presence, proactive nudging of a driver to active advanced driver-assistance systems (ADAS) when available, and/or other functions.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

Example 1: A method includes executing, by processing circuitry of a vehicle, a vehicle hardware abstraction layer and a vehicle composite signal framework, where the vehicle composite signal framework manages component signals obtained from a plurality of vehicle services of the vehicle; obtaining, by the processing circuitry, a component signal from a vehicle service of the plurality of vehicle services; processing, by the processing circuitry, the component signal into composite signal based on a mapping of the vehicle services to vehicle properties; and providing, by the processing circuitry, the composite signal to an application executed by the processing circuitry.

Example 2: The method of example 1, wherein processing the component signal into the composite signal includes: associating the composite signal with a vehicle property of a plurality of vehicle properties via a declarative mapping of the composite signal to the vehicle property.

Example 3: The method of example 2, wherein the service is a first service, wherein the component signal is a first component signal, and wherein associating the composite signal further comprises: associating a second composite signal with the vehicle property of the plurality of vehicle properties.

Example 4: The method of any of examples 1 through 3, wherein the vehicle services include at least one component of the vehicle and are representative of functions of the at least one component.

Example 5: The method of any of examples 1 through 4, wherein the component signal includes a plurality of component signals, and wherein processing the component signal into the composite signal further comprises: aggregating the plurality of component signals into the composite signal.

Example 6: The method of any of examples 1 through 5, wherein processing the component signal includes processing the component signal to conform to a standard associated with the mapping to vehicle properties.

Example 7: The method of any of examples 1 through 6, wherein providing the composite signal further comprises: providing the composite signal via an application programming interface to the application.

Example 8: The method of any of examples 1 through 7, wherein the vehicle composite signal framework is agnostic of vehicle manufacturer.

Example 9: The method of any of examples 1 through 8, wherein providing the composite further comprises: providing the composite signal in response to a query from the application.

Example 10: The method of any of examples 1 through 9, wherein the component signal is pre-processed by a component of the vehicle prior to being obtained by the processing circuitry.

Example 11: A vehicle includes memory; and processing circuitry in communication with the memory and configured to: execute a vehicle hardware abstraction layer and a vehicle composite signal framework, where the vehicle composite signal framework manages component signals obtained from a plurality of vehicle services of the vehicle; obtain a component signal from a vehicle service of the plurality of vehicle services; process the component signal into composite signal based on a mapping of the vehicle services to vehicle properties; and provide the composite signal to an application executed by the processing circuitry.

Example 12: The vehicle of example 11, wherein to process the component signal into the composite signal, the processing circuitry is further configured to: associate the composite signal with a vehicle property of a plurality of vehicle properties via a declarative mapping of the composite signal to the vehicle property.

Example 13: The vehicle of example 12, wherein the service is a first service, wherein the component signal is a first component signal and wherein to associate the component signal, the processing circuitry is further configured to: associate a second composite signal with the vehicle property of the plurality of vehicle properties.

Example 14: The vehicle of any of examples 11 through 13, wherein the vehicle services include at least one component of the vehicle and are representative of functions of the at least one component.

Example 15: The vehicle of any of examples 11 through 14, wherein the component signal includes a plurality of component signals, and wherein to process the component signal to the composite signal, the processing circuitry is further configured to: aggregate the plurality of component signals into the composite signal.

Example 16: A non-transitory computer-readable storage media encoded with instructions that, when executed, cause at least one processor of a vehicle computing device to: execute a vehicle hardware abstraction layer and a vehicle composite signal framework, where the vehicle composite signal framework manages component signals obtained from a plurality of vehicle services of the vehicle; obtain a component signal from a vehicle service of the plurality of vehicle services; process the component signal into composite signal based on a mapping of the vehicle services to vehicle properties; and provide the composite signal to an application executed by the at least one processor.

Example 17: The non-transitory computer-readable storage media of example 16, wherein to process the component signal into the composite signal, the instructions further cause the at least one processor to: associate the composite signal with a vehicle property of a plurality of vehicle properties via a declarative mapping of the composite signal to the vehicle property.

Example 18: The non-transitory computer-readable storage media of example 17, wherein the service is a first service, wherein the component signal is a first component signal and wherein to associate the component signal, the instructions are further configured to cause the at least one processor to: associate a second composite signal with the vehicle property of the plurality of vehicle properties.

Example 19: The non-transitory computer-readable storage media of any of examples 16 through 18, wherein the vehicle services include at least one component of the vehicle and are representative of functions of the at least one component.

Example 20: The non-transitory computer-readable storage media of any of examples 16 through 19, wherein the component signal includes a plurality of component signals, and wherein to process the component signal to the composite signal, the instructions are further configured to cause the at least one processor to: aggregate the plurality of component signals into the composite signal.

Example 21: The method of example 1, wherein executing the vehicle hardware abstraction layer further comprises executing the vehicle composite signal framework in the vehicle hardware abstraction layer or as a surface built on the vehicle hardware abstraction layer.

What is claimed is:

1. A method comprising:
executing, by processing circuitry of a vehicle, a vehicle hardware abstraction layer and a vehicle composite signal framework, where the vehicle composite signal framework manages component signals obtained from a plurality of vehicle services of the vehicle;
obtaining, by the processing circuitry, a component signal from a vehicle service of the plurality of vehicle services;
processing, by the processing circuitry, the component signal into composite signal based on a mapping of the vehicle services to vehicle properties; and
providing, by the processing circuitry, the composite signal to an application executed by the processing circuitry.

2. The method of claim 1, wherein processing the component signal into the composite signal includes:
associating the composite signal with a vehicle property of a plurality of vehicle properties via a declarative mapping of the composite signal to the vehicle property.

3. The method of claim 2, wherein the service is a first service, wherein the component signal is a first component signal, and wherein associating the composite signal further comprises:
associating a second composite signal with the vehicle property of the plurality of vehicle properties.

4. The method of claim 1, wherein the vehicle services include at least one component of the vehicle and are representative of functions of the at least one component.

5. The method of claim 1, wherein the component signal includes a plurality of component signals, and wherein processing the component signal into the composite signal further comprises:
aggregating the plurality of component signals into the composite signal.

6. The method of claim 1, wherein processing the component signal includes processing the component signal to conform to a standard associated with the mapping to vehicle properties.

7. The method of claim 1, wherein providing the composite signal further comprises:
providing the composite signal via an application programming interface to the application.

8. The method of claim 1, wherein the vehicle composite signal framework is agnostic of vehicle manufacturer.

9. The method of claim 1, wherein providing the composite further comprises:
providing the composite signal in response to a query from the application.

10. The method of claim 1, wherein the component signal is pre-processed by a component of the vehicle prior to being obtained by the processing circuitry.

11. A vehicle, comprising:
memory; and
processing circuitry in communication with the memory and configured to:
execute a vehicle hardware abstraction layer and a vehicle composite signal framework, where the vehicle composite signal framework manages component signals obtained from a plurality of vehicle services of the vehicle;
obtain a component signal from a vehicle service of the plurality of vehicle services;
process the component signal into composite signal based on a mapping of the vehicle services to vehicle properties; and
provide the composite signal to an application executed by the processing circuitry.

12. The vehicle of claim 11, wherein to process the component signal into the composite signal, the processing circuitry is further configured to:
associate the composite signal with a vehicle property of a plurality of vehicle properties via a declarative mapping of the composite signal to the vehicle property.

13. The vehicle of claim 12, wherein the service is a first service, wherein the component signal is a first component signal and wherein to associate the component signal, the processing circuitry is further configured to:
associate a second composite signal with the vehicle property of the plurality of vehicle properties.

14. The vehicle of claim 11, wherein the vehicle services include at least one component of the vehicle and are representative of functions of the at least one component.

15. The vehicle of claim 11, wherein the component signal includes a plurality of component signals, and wherein to process the component signal to the composite signal, the processing circuitry is further configured to:
aggregate the plurality of component signals into the composite signal.

16. A non-transitory computer-readable storage media encoded with instructions that, when executed, cause at least one processor of a vehicle computing device to:
execute a vehicle hardware abstraction layer and a vehicle composite signal framework, where the vehicle composite signal framework manages component signals obtained from a plurality of vehicle services of the vehicle;
obtain a component signal from a vehicle service of the plurality of vehicle services;
process the component signal into composite signal based on a mapping of the vehicle services to vehicle properties; and
provide the composite signal to an application executed by the at least one processor.

17. The non-transitory computer-readable storage media of claim 16, wherein to process the component signal into the composite signal, the instructions further cause the at least one processor to:
associate the composite signal with a vehicle property of a plurality of vehicle properties via a declarative mapping of the composite signal to the vehicle property.

18. The non-transitory computer-readable storage media of claim 17, wherein the service is a first service, wherein the component signal is a first component signal and wherein to associate the component signal, the instructions are further configured to cause the at least one processor to:
associate a second composite signal with the vehicle property of the plurality of vehicle properties.

19. The non-transitory computer-readable storage media of claim 16, wherein the vehicle services include at least one component of the vehicle and are representative of functions of the at least one component.

20. The non-transitory computer-readable storage media of claim 16, wherein the component signal includes a plurality of component signals, and wherein to process the component signal to the composite signal, the instructions are further configured to cause the at least one processor to:
aggregate the plurality of component signals into the composite signal.
